(19) United States
(12) Patent Application Publication
(10) Pub. No.: US 2020/0017710 A1
(43) Pub. Date: Jan. 16, 2020

(54) Coating for Windshield

(71) Applicant: Bell Helicopter Textron Inc., Fort Worth, TX (US)

(72) Inventors: William P. Sumner, Kingsport, TN (US); William Lewis Neal, II, Abingdon, VA (US); Robert Matson, Bluff City, TN (US); David Kimble Huber, Piney Flats, TN (US)

(21) Appl. No.: 16/289,600

(22) Filed: Feb. 28, 2019

Related U.S. Application Data
(60) Provisional application No. 62/698,862, filed on Jul. 16, 2018.

(51) Int. Cl. C09D 175/04; B64C 1/14

(52) U.S. Cl. CPC C09D 175/04; C09J 5/02; B64C 1/1484

(57) ABSTRACT

Briefly, the disclosure relates to films, such as polyurethane films, which may be utilized to coat a windshield of an aircraft, such as a rotary-wing or a fixed-wing aircraft. In particular implementations, prior to application of a polyurethane film to an aircraft windshield, the polyurethane film may be exposed to an elevated temperature for an appropriate duration, which may operate to decrease stresses internal to the polyurethane film as well as to soften the polyurethane film. A slip solution may be applied to the aircraft windshield, so as to permit sliding of the polyurethane film relative to the windshield. After application of the slip solution, a tack solution may be applied, which may operate to remove the slip solution, thereby permitting the polyurethane film to be affixed to the windshield.

### CROSS-REFERENCE TO RELATED APPLICATIONS

This application claims the benefit of U.S. provisional patent application Ser. No. 62/698,862, filed 2018 Jul. 16 and titled FILM COATED WINDSHIELD, the entire disclosure of which is herein incorporated by reference.

### STATEMENT REGARDING FEDERALLY SPONSORED RESEARCH OR DEVELOPMENT

Not applicable.

### BACKGROUND

This section is intended to provide background information to facilitate an understanding of various technologies described herein. As the section's title implies, this is a discussion of related art. That such art may be related in no way implies that such art is prior art. It should therefore be understood that the statements in this section are to be read in this light and not as admissions of prior art.

In various types of rotary-wing aircraft, such as helicopters and tiltrotor aircraft, one or more windshields may provide visibility to allow a pilot and/or copilot to observe and analyze surroundings external to the aircraft. An unobstructed, distortion-free view of external surroundings may permit an aircrew to safely pilot an aircraft. In military environments, a distortion-free view of external surroundings may additionally permit an aircrew to observe potential threats and to engage such potential threats appropriately. However, certain flight operations of many rotary-wing aircraft, such as those that involve low-altitude “nap-of-the-earth” flight regimes, may subject the aircraft to airborne dust, dirt particles and/or other debris. Such debris may be especially damaging to windshields of rotary-wing aircraft, which may be at least partially horizontally-oriented and thus exposed to a large amount of rotor downwash. Such rotor downwash may include large amounts of dust and/or debris, which may be especially damaging during takeoff and landing of rotary-wing aircraft, for example.

Accordingly, it may be appreciated that windshields of rotary-wing aircraft, especially in military environments in which aircraft may be frequently refueled and/or rearmed at forward operating bases that lack paved runways, may require frequent maintenance and/or replacement. Such replacement and/or maintenance of windshields of rotary-wing aircraft may be especially crucial during combat operations when pilots and/or copilots may be required to observe and/or engage targets operating at extended ranges. Under these circumstances, and others, an ability to clearly view and evaluate potential targets may be essential to mission success.

### SUMMARY

Briefly, various implementations of claimed subject matter may relate to methods for applying a coating to a windshield. The method may include exposing a film, wherein the film includes an adhesive backing, to an elevated temperature for a duration sufficient to obtain a substantially uniform distribution of the adhesive of the backing. In some implementations, exposure of the film to an elevated temperature may operate to relieve stresses internal to the film. The method may additionally include applying a slip solution between the adhesive of the backing of the exposed film and the windshield to permit a sliding movement between the exposed film and the windshield. The method may further include applying a tack solution between the adhesive of the exposed film and the windshield. In an implementation, the elevated temperature may include a temperature of between about 37.0° C. and about 80.0° C. In an implementation, the duration of exposure to the elevated temperature may comprise between about 45.0 minutes and about 180.0 minutes. Exposure of the film to the elevated temperature may operate to relieve internal stresses of the film brought about by interactions among molecules of the film.

In the above-identified method, the tack solution may comprise a solution of at least 5.0% alcohol. In particular implementations, the above-identified windshield may comprise a bend radius, in at least a first direction, of less than about 25.0 cm (approximately 10.0 inches). In other implementations, the above-identified windshield may comprise a more complex, two-dimensional curvature, such as a curvature comprising a bend radius of less than about 25.0 cm (approximately 10.0 inches) along both first and second axes. In an implementation, the exposed film adhered to the windshield may comprise a thickness of between about 100.0 μm and about 250.0 μm. In an implementation, when the exposed film is adhered to the windshield, the film may exhibit less than 5.0% optical distortion in any direction in a visible wavelength. In an implementation, the exposed film may comprise at least 50.0% polyurethane. In an implementation, exposing the film to the elevated temperature operates to bring about a substantially uniform thickness of the adhesive of the backing. In an implementation, at least a portion of the slip solution is displaced in response to applying the tack solution between the adhesive of the exposed film and the windshield. In an implementation, a soft edge of a flattening tool scraping implement may be applied to affix the exposed film into place, wherein a friction-reducing solution is dispensed between the flattening tool and the exposed film, wherein the friction-reducing solution includes a solution of at least 5.0% surfactant.

In various implementations, a windshield may include a film, which may be adhered to the windshield, wherein the film includes at least 50.0% polyurethane and having an adhesive backing. The film may exhibit less than 5.0% optical distortion in any direction in a visible wavelength. The film may include a thickness of between 100.0 μm and 250.0 μm. In an implementation, the windshield to which the film is adhered may comprise a bend radius, in at least a first direction, of less than about 25.0 cm (approximately 10.0 inches). In an implementation, the film may be exposed to an elevated temperature of between about 37.0° C. (approximately 100.0° F.) and 80.0° C. (approximately 176.0° F.), which may relieve internal stresses brought about by interactions among adjacent molecules of the exposed film. In at least one implementation, exposure of the polyurethane film to an elevated temperature may operate to soften the polyurethane film.

In various implementations, an aircraft may include a windshield that has a film adhered to the windshield via exposure of the film to an elevated temperature for a duration to obtain a substantially uniform distribution of adhesive. In addition, a slip solution may be applied between the adhesive and the windshield so as to permit a sliding movement between the film and the windshield. Further, a tack solution may be applied between the adhesive of the exposed film and the windshield. In an implementation, adhering the film to the windshield may additionally involve application of a flattening tool against the film to affix the film onto the windshield. In an implementation, the elevated temperature used in exposing the film may comprise a range of between about 37.0° C. and about 80.0° C. In an implementation, the duration of exposure of the film may comprise between about 45.0 minutes and about 180.0 minutes.

### BRIEF DESCRIPTION OF THE DRAWINGS

The present technique(s) will be described further, by way of example, with reference to implementations thereof as illustrated in the accompanying drawings. It should be understood, however, that the accompanying drawings illustrate only the various implementations described herein and are not meant to limit the scope of various techniques, methods, systems, or apparatuses described herein.

FIG. 1 is an illustration of a windshield positioned on a representative rotary-wing aircraft according to various implementations described herein;

FIG. 2 is an illustration of the windshield of FIG. 1 showing a bend radius, in at least a first direction, of a portion of the windshield according to an implementation described herein;

FIG. 3 is an illustration of a roll of a polyurethane film for application to the windshield of FIG. 1 according to an implementation described herein;

FIG. 4A is an illustration showing an arrangement of polymers of a polyurethane film, prior to exposure to an elevated temperature, according to an implementation described herein;

FIG. 4B is an illustration showing an arrangement of polymers of a polyurethane film, in response to exposure to an elevated temperature, according to an implementation described herein;

FIG. 5 is an illustration showing application of a slip solution to a polyurethane film according to another implementation described herein;

FIG. 6 is an illustration showing application of a tack solution to a polyurethane film according to another implementation described herein;

FIG. 7 is an illustration showing a soft edge of a flattening tool augmented so as to evenly distribute force to a polyurethane film while affixing the polyurethane film to a windshield according to another implementation described herein; and

FIG. 8 is a flow chart for a method of applying a coating to windshield according to an implementation described herein.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other implementations may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict the scope of claimed subject matter. Therefore, the following detailed description is not to be taken to limit claimed subject matter and/or equivalents.

### DETAILED DESCRIPTION

As previously mentioned, in various types of rotary-wing aircraft, such as helicopters and tiltrotor aircraft, one or more windshields may provide visibility to allow a pilot and/or copilot to observe and to analyze surroundings external to the aircraft. In many instances, a premium may be placed on optical clarity of an aircraft windshield, so as to provide a distortion-free and unobstructed view of surroundings external to the aircraft. Such optical clarity may enable an aircrew to safely pilot the aircraft as well as allowing passengers to view scenery visible from, for example, sightseeing aircraft. In military environments, such optical clarity may be especially useful in determining and/or engaging enemy targets using, for example, air-to-ground rockets and missiles.

However, windshields of low-flying rotary-wing aircraft, particularly rotary-wing aircraft flying nap-of-the-earth profiles, may be subjected to above-average amounts of dust and/or debris, which may be churned up by rotor downwash. In particular instances, in which windshields of rotary-wing aircraft may be at least partially horizontally oriented, such windshields may be subjected to large amounts of airborne dust, dirt particles, and/or other debris. Such debris, which may become dislodged by rotor downwash from unpaved helicopter or rotary-wing aircraft landing pads, may operate to abrade and/or damage windshields of rotary-wing aircraft especially during takeoff and/or landing operations. In at least some instances, such damage to rotary-wing aircraft windshields may impede aircrew visibility of the surrounding environment, which may, in turn, degrade the capability of the aircrew to safely pilot the aircraft. In particular circumstances, such as during combat operations, damage to windshields of rotary-wing aircraft may impede the aircrew's ability to engage enemy targets, thereby jeopardizing crew safety and/or mission success. Accordingly, it may be appreciated that windshields of rotary-wing aircraft, especially in military environments in which aircraft may be frequently refueled and/or rearmed at forward operating bases that lack paved landing pads, may require frequent maintenance and/or replacement. It may further be appreciated that various types of rotary-wing aircraft as well as fixed-wing aircraft may benefit from an improved process for reducing the possibility of incurring damage to rotary-wing aircraft windshields.

In particular implementations, a method for coating an aircraft windshield may provide an effective technique that may be practiced using a minimum number of special tools and/or specialized materials. In certain implementations, such techniques may be practiced, for example, by maintenance personnel operating in the field such as, for example, at forward rearm/refuel areas. In an implementation, such techniques may include coating of an aircraft windshield, comprising a complex curvature, without giving rise to significant optical distortion, which may be produced by bubbles trapped between the coating and the aircraft windshield. As a result of the application of a coating, such as a polyurethane coating, to an aircraft windshield, the windshield may become highly resistant to airborne dirt, for example, which may become dislodged from the ground by rotor downwash especially during takeoff and landing operations. A coated aircraft windshield may additionally be resistant to damage from larger airborne projectiles, such as rocks, birds, twigs, shrapnel, and so forth, which may bring about cracking or breaking of an uncoated aircraft windshield. Further, at least in particular instances, certain types of damage to a coated aircraft windshield may be limited to the coating itself, thereby reducing, or perhaps eliminating entirely, a need to replace an aircraft windshield. Rather, in such instances, an aircraft may be returned to service after removal and replacement of a windshield coating only, without requiring removal and replacement of an entire windshield.

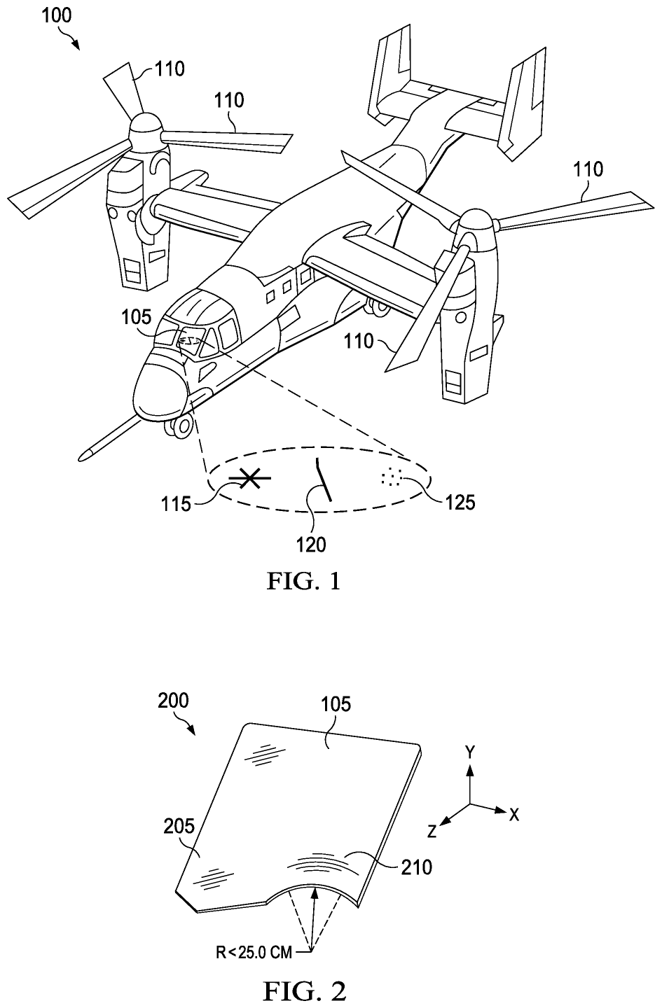

FIG. 1 is an illustration 100 of a windshield positioned on a representative rotary-wing aircraft according to various implementations described herein. It may be appreciated that although illustration 100 depicts a tiltrotor aircraft, implementations of claimed subject matter may be beneficial to a wide variety of aircraft, such as helicopters or other rotary-wing aircraft, as well as fixed-wing aircraft, for example. Additionally, although illustration 100 depicts windshield 105, which may permit viewing of surroundings in a forward direction, other types of windshields may benefit from implementations of claimed subject matter, such as windshields that permit viewing to the sides or to the rear of the aircraft, for example.

It may be appreciated that windshield 105 be oriented in a direction comprising a significant horizontal component. Accordingly, during, for example, takeoff and/or landing operations, especially utilizing an unpaved landing pad, rotor downwash from rotor blades 110 may be directed toward windshield 105. Further, rotor downwash from rotor blades 110 may comprise rocks, dirt, and/or other debris, which may impact an exposed surface of windshield 105. As shown in FIG. 1, such impacts may bring about damage to windshield 105 such as, for example, dimple 115, scratch 120, and pit marks 125. In some instances, dimples, scratches, and other features may degrade optical clarity of windshield 105, which may negatively impact an aircrew's ability to safely pilot, for example, the rotary-wing aircraft of FIG. 1.

FIG. 2 is an illustration 200 of the windshield of FIG. 1 showing structural details of the windshield according to an implementation described herein. As shown in FIG. 2, windshield 105 may comprise relatively flat, horizontally-oriented portion 205, located at a forward portion of the windshield. Windshield 105 may additionally comprise curved portion 210. In the implementation of FIG. 2, curved portion 210 of windshield 105 may include a surface having a bend radius of, for example, less than 25.0 cm (about 10.0 inches) in at least a first direction. However, in other implementations, windshields similar to windshield 105 may include a surface having a smaller bend radius (e.g., in at least a first direction), such as a bend radius of 20.0 cm, 15.0 cm, etc. In still other implementations, a windshield similar to windshield 105 may include a surface having a larger bend radius, such as a bend radius of 30.0 cm, 35.0 cm, etc., and may comprise complex curvatures exhibiting bending in two or more directions. It should be noted that claimed subject matter is intended to embrace a wide variety of windshields comprising curved surfaces, such as a bubble- or spherically-shaped surfaces, depressed surfaces, etc.

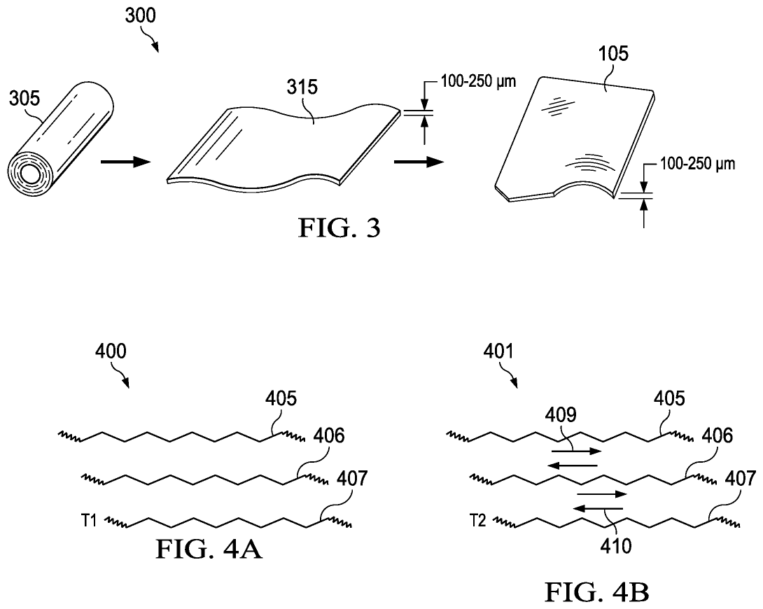

FIG. 3 is an illustration 300 of a roll or coiled polyurethane film for application to the windshield of FIG. 1 according to an implementation described herein. In particular implementations, roll 305 may comprise a material including at least 50.0% polyurethane having a thickness of between about 100.0 μm and about 250.0 μm, which may be rolled or coiled about a central axis. When a portion of roll 305 is unrolled and separated into one or more smaller segments, for example, so as to comprise substantially flat portion 315, the separated portion 315 may be inclined to curl, so as to revert a shape similar to roll 305. Accordingly, at least in particular implementations, cutting and/or coercing substantially flat portion 315 to conform to a complex shape, such as a shape similar to windshield 105, may prove to be a cumbersome and/or unwieldy process.

FIG. 4A is an illustration 400 showing an arrangement of polymers of a polyurethane film, prior to exposure to an elevated temperature according to an implementation described herein. In illustration 400, polymeric molecules 405, 406, and 407 may represent a large number of polymers that comprise substantially flat portion 315, which has been separated from polyurethane roll 305 (of FIG. 3). Accordingly, although only 3 polymeric molecules (405, 406, and 407) are depicted in FIG. 4A, substantially flat portion 315 cut from polyurethane roll 305 may comprise billions of polymeric molecules, trillions of polymeric molecules, and so forth, virtually without limitation.

In FIG. 4A, individual portions of polymeric molecule 405 may interact with individual portions of polymeric molecule 406. Additionally, individual portions of polymeric molecule 406 may interact with individual portions of polymeric molecule, 407. Such interactions may include, fusing of a first polymeric molecule with a second polymeric molecule, such as by way of covalent bonding. Such fusing among portions of adjacent polymeric molecules may operate to restrict or to inhibit relative motion of, for example, polymeric molecule 405 with respect to polymeric molecule 406. As a consequence to fusing or entangling among portions of adjacent polymeric molecules, it may be difficult to form substantially flat portion 315 utilizing a portion of film separated from polyurethane roll 305. Further, attempts to form substantially flat portion 315 may give rise to increasing internal stresses among polymeric molecules of a polyurethane film, which may be brought about fusing among polymeric molecules of substantially flat portion 315.

However, in response to exposing polymeric molecules 405, 406, and 407 to an elevated temperature, such as a temperature of between about 37.0° C. (about 100.0° F.) and about 80.0° C. (about 176.0° F.), fusing or other types of entanglement among polymeric molecules 405, 406, and 407 with adjacent polymeric molecules may be decreased. Additionally, such exposure to an elevated temperature may operate to soften the polyurethane film. Thus, FIG. 4B (illustration 401) shows an arrangement of polymers of a polyurethane film in response to exposure to an elevated temperature according to an implementation described herein. In FIG. 4B, in response to an absence of (such as shown in FIG. 4A), polymeric molecules 405, 406, and 407 may be capable of more freely moving with respect to each other. Thus, as indicated by arrows 409 and 410, polymeric molecules 405, 406, and 407 may be capable of relative movement (e.g., sliding) with respect to each other. Such a capability for relative movement of polymeric molecules with respect to each other may give rise to an ability to more easily form substantially flat portion 315 utilizing a portion of film separated from polyurethane roll 305.

It should be noted that decreasing the above-described fusing or reduction other types of entanglement among polymeric molecules of a polyurethane film, may be accomplished via exposure of the polyurethane film to an elevated temperature, such as a temperature of between about 37.0° C. (about 100.0° F.) and about 80.0° C. (about 176.0° F.) for a duration of between approximately 45.0 minutes and 180.0 minutes. In particular implementations, such exposure of the polyurethane film to elevated temperatures may operate to soften and/or reduce stresses internal to the polyurethane film. However, in other implementations, stresses internal to a polyurethane film may be decreased utilizing differing elevated temperature ranges, such as temperature ranges of about 49.0° C. (about 120.0° F.) to about 71.0° C. (about 160.0° F.) for a duration of between about 60.0 minutes and about 180.0 minutes. In particular implementations, an elevated temperature range to which a polyurethane film may be exposed, as well as a duration of such exposure, may be empirically determined utilizing a temperature range sufficient to decrease fusing or other type of interference and/or entanglement among polymeric molecules of a polyurethane film. Accordingly, in particular implementations, a polyurethane film, for example, may be exposed to virtually any elevated temperature over virtually any duration so long as such exposure is sufficient to soften and/or reduce fusing or other type entanglement among polymeric molecules of a polyurethane film. Further, in certain implementations, an elevated temperature range to which a polyurethane film may be exposed, as well as a duration of such exposure, may additionally operate to uniformly distribute an adhesive applied to a backing of the polyurethane film.

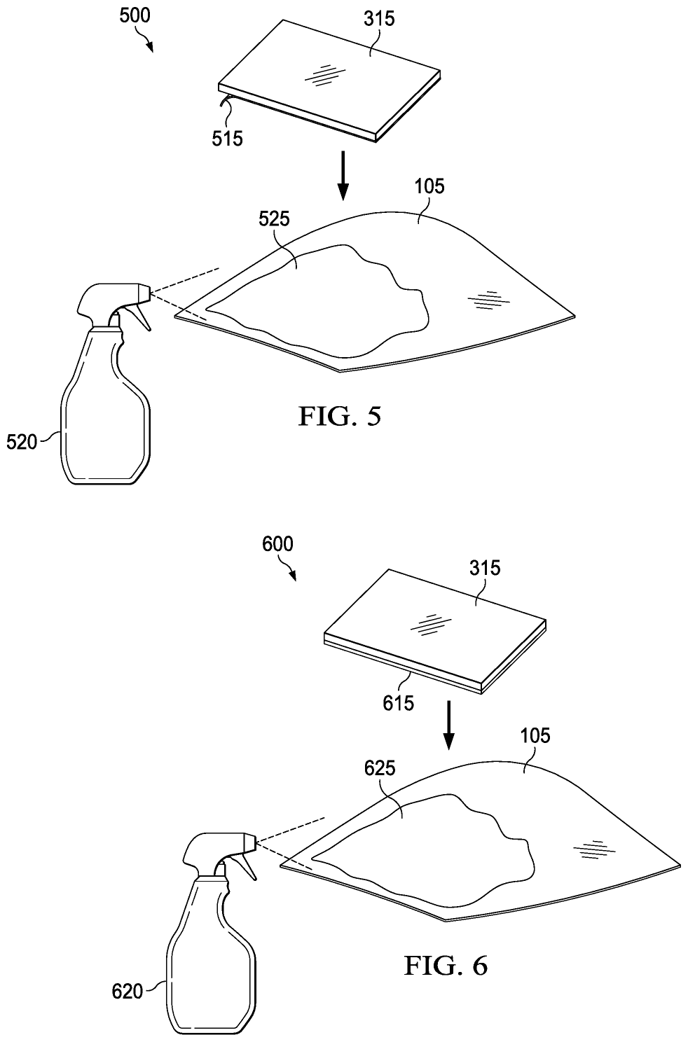

As shown illustration 500 (FIG. 5) after exposure of a portion of polyurethane film 315 to an elevated temperature, a protective covering may be removed, so as to expose an adhesive backing. Thus, as shown in FIG. 5, protective covering 515 may be peeled away from polyurethane film 315, thereby exposing an adhesive backing. Prior to placing polyurethane film 315 into contact with windshield 105, slip solution 525 may be applied. In particular implementations, slip solution 525 may operate to permit slidable movement of polyurethane film 315 over windshield 105. Accordingly, in response to application of slip solution 525 via spray dispensing bottle 520, polyurethane film 315 may be positioned and/or trimmed to fit within boundaries of windshield 105. In particular implementations, slip solution 525 may comprise a surfactant, such as an anionic surfactant or an ionic surfactant, having a concentration of at least 5.0%, although claimed subject matter is not limited in this respect. In other implementations, a slip solution may comprise a different solution, such as common dishwashing liquid. It should be noted that claimed subject matter is intended to embrace any slip solution that may permit an adhesive-backed polyurethane film to move slidably with respect to windshield 105 without allowing significant adhesion between the polyurethane film and windshield 105, and claimed subject matter is not limited in this respect.

In an implementation, after polyurethane film 315 has been positioned on windshield 105, a tack solution, such as shown in illustration 600 (FIG. 6), may be applied. In an implementation, a tack solution, such as tack solution 625 applied via spray dispensing bottle 620, may comprise an alcohol, such as methyl alcohol, ethyl alcohol, propyl alcohol, isopropyl alcohol, butyl alcohol, isobutyl alcohol, and so forth, and claimed subject matter is not limited in this respect. In other implementations, a tack solution may comprise any liquid that may operate to displace or to remove a previously applied slip solution. In response to application of a tack solution, polyurethane film 315 may be adhered to windshield 105 via adhesive backing 615.

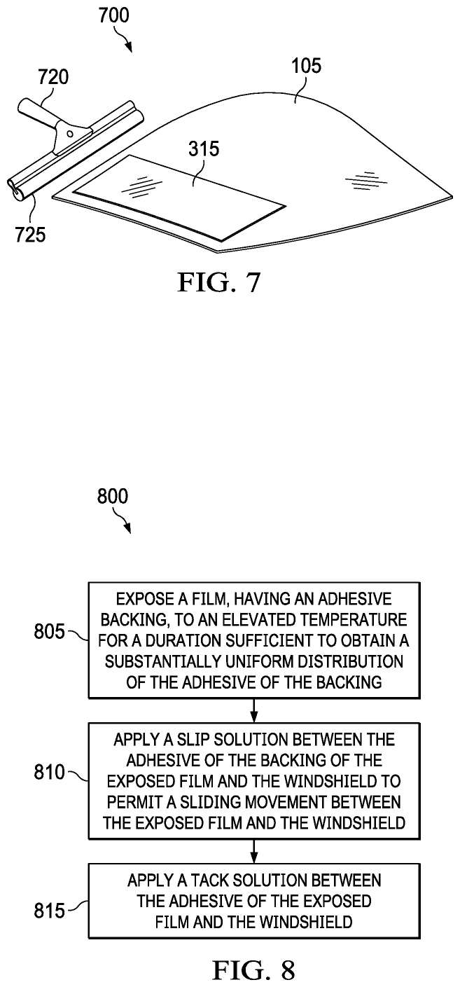

FIG. 7 is an illustration 700 showing a squeegee having a soft edge augmented so as to more evenly distribute force to a polyurethane film while affixing the polyurethane film to a windshield according to another implementation described herein. In other implementations, as an alternative to the use of a squeegee, a scraping implement, straightening tool, an edge comprising a pliant or rubber material, or any other type of flattening tool or implement may be utilized to assist in flattening and/or affixing the polyurethane film to the windshield. The squeegee of FIG. 7 may comprise blade 725, which includes a soft or pliant material, such as rubber, which may be affixed to handle 720. In particular implementations, at least a portion of blade 725 may be augmented via wrapping the blade in an absorbent material, such as a common towel, for example, which may absorb (and subsequently dispense) a friction-reducing liquid, such as a liquid comprising a surfactant. In particular implementations, a friction-reducing liquid may comprise at least 5.0% of an ionic or anionic surfactant, for example. In certain implementations, presence of a friction-reducing liquid within an absorbent material wrapped around at least a portion of blade 725 may permit the friction-reducing solution to be dispensed from the absorbent material to the surface of polyurethane film 315. Thus, during installation of polyurethane film 315 over windshield 105, forces applied via handle 720 may be relatively evenly distributed over the surface of polyurethane film 315. This may allow air bubbles that may form between polyurethane film 315 and windshield 105 to be pushed toward edges of polyurethane film 315 without inducing movement of film 315.

FIG. 8 is a flow chart 800 for a method for applying a coating to a windshield according to an implementation. FIG. 8 may include blocks in addition to those shown and described or may include fewer blocks than those shown and described. In addition, blocks may occur in an order different than indicated in FIG. 8. A coating for an aircraft windshield may comprise a material comprising at least 50.0% polyurethane and having a thickness of between 100.0 μm and 250.0 μm, although claimed subject matter is not limited in this respect. In an implementation, the method may begin at block 805, which may include exposing a polyurethane film, wherein the film includes an adhesive backing, to an elevated temperature for a duration sufficient to substantially reduce internal stresses, such as internal stresses brought about by fusing of adjacent polymeric molecules of the polyurethane film. Exposure of a polyurethane film to an elevated temperature may additionally operate to soften the polyurethane film and bring about a substantially uniform distribution and/or thickness of adhesive of an adhesive backing.

The method of flowchart 800 may continue at block 810, which may comprise applying a slip solution between the adhesive backing of the exposed film and the windshield. In particular implementations, application of a slip solution may permit the polyurethane film to slide relative to a windshield. In certain implementations, an ability for a polyurethane film to slide relative to the windshield may enable the polyurethane film to be trimmed and precisely positioned on the windshield.

The method of flowchart 800 may continue at block 815, which may comprise applying a tack solution between the adhesive of the exposed film and the windshield. In particular implementations, applying a tack solution may operate to displace and/or remove a slip solution, such as the slip solution applied at block 810. Thus, in one particular implementation, one or more individual corners of the film may be separated from the windshield so as to create a localized gap between the film and the windshield. The tack solution may then be dispensed, such as by way of a spray dispensing bottle, within the gap formed between the film and the windshield. After a sufficient amount of tack solution has been dispensed within the localized gap, so as to displace at least a substantial portion of the previously applied slip solution, the film may again be placed into contact with the windshield.

In certain implementations, the method may include an additional step of applying a flattening tool, such as a rubber blade of “squeegee,” which may be at least partially wrapped with a cloth, such as a towel, so as to augment a soft edge of the squeegee or flattening tool. Such augmenting of and edge of a squeegee or other type of flattening tool may permit substantially even distribution of forces applied to the exposed film, which may allow air bubbles, which may have formed between the exposed film and the windshield, to be urged toward the edges of the exposed film. In particular implementations, a friction-reducing solution may be dispensed between the flattening tool and the film, which may allow the exposed film to be securely affixed to the windshield without giving rise to tearing, streaking, or otherwise damaging the film.

Although illustrative implementations of claimed subject matter have been described in detail herein with reference to the accompanying drawings, it is to be understood that the invention is not limited to those precise implementations, and that various changes, additions and modifications can be effected therein by one skilled in the art without departing from the scope of the invention as defined by the appended claims. For example, various combinations of the features of the dependent claims could be made with the features of the independent claims without departing from the scope of claimed subject matter.

What is claimed is:

1. A method for applying a coating to a windshield, comprising:
exposing a film, having an adhesive backing, to an elevated temperature for a duration sufficient to obtain a substantially uniform distribution of the adhesive of the backing;
applying a slip solution between the adhesive of the backing of the exposed film and the windshield to permit a sliding movement between the exposed film and the windshield; and
applying a tack solution between the adhesive of the exposed film and the windshield.

2. The method of claim 1, wherein the elevated temperature includes a temperature of between about 37.0° C. and about 80.0° C.

3. The method of claim 1, wherein the duration comprises between about 45.0 minutes and about 180.0 minutes.

4. The method of claim 1, wherein exposing of the film additionally operates to relieve internal stresses of the film brought about by interactions among molecules of the film.

5. The method of claim 1, wherein the tack solution comprises at least 5.0% alcohol.

6. The method of claim 1, wherein the windshield comprises a bend radius of less than 25.0 cm in at least a first direction.

7. The method of claim 1, wherein the exposed film comprises a thickness dimension of between 100.0 μm and 250.0 μm.

8. The method of claim 1, wherein the exposed film adhered to the windshield exhibits less than 5.0% optical distortion in any direction in a visible wavelength.

9. The method of claim 1, wherein the film comprises at least 50.0% polyurethane.

10. The method of claim 1, wherein exposing the film to the elevated temperature operates to bring about a substantially uniform thickness of the adhesive of the backing.

11. The method of claim 1, wherein at least a portion of the slip solution is displaced in response to applying the tack solution between the adhesive of the exposed film and the windshield.

12. The method of claim 1, further comprising:
applying a soft edge of a flattening tool to affix the exposed film into place, wherein a friction-reducing solution is dispensed between the soft edge of the flattening tool and the exposed film.

13. The method of claim 12, wherein the friction-reducing solution includes a solution of at least 5.0% surfactant.

14. A windshield, comprising:
a film, adhered to the windshield, wherein the film includes at least 50.0% polyurethane and having an adhesive backing, wherein
the film exhibits less than 5.0% optical distortion in any direction in a visible wavelength, and wherein
the film comprises a thickness of between 100.0 μm and 250.0 μm.

15. The windshield of claim 14, wherein the windshield comprises a bend radius, in at least a first direction, of less than about 25.0 cm.

16. The windshield of claim 14, wherein the film is exposed to an elevated temperature of between about 37.0° C. and 80.0° C. to relieve internal stresses brought about by interactions among adjacent molecules of the exposed film.

17. An aircraft, comprising:
a windshield that has a film adhered to the windshield via:
a) exposure of the film to an elevated temperature for a duration to obtain a substantially uniform distribution of adhesive;
b) an application of a slip solution between the adhesive and the windshield so as to permit a sliding movement between the film and the windshield; and
c) an application of a tack solution between the adhesive of the exposed film and the windshield.

18. The aircraft of claim 17, wherein the film is further adhered to the windshield via an application of a soft edge of a flattening tool against the film to affix the film onto the windshield.

19. The aircraft of claim 17, wherein the elevated temperature comprises a range of between about 37.0° C. and about 80.0° C.

20. The aircraft of claim 17, wherein the duration comprises between about 45.0 minutes and about 180.0 minutes.
